(19) United States
(12) Patent Application Publication
(10) Pub. No.: US 2011/0292659 A1
(43) Pub. Date: Dec. 1, 2011

(54) LIGHT BULB AND LIGHTING FIXTURE CAPABLE OF REDUCING ELECTROMAGNETIC RADIATION

(76) Inventors: Tsang-Yen Hsieh, New Taipei City (TW); Jyh-Liang Wang, New Taipei City (TW)

(21) Appl. No.: 13/115,227

(22) Filed: May 25, 2011

(30) Foreign Application Priority Data
May 31, 2010 (TW) 099117346

(51) Int. Cl. F21V 5/00; H01J 1/62; F21V 1/00; H01J 5/50

(52) U.S. Cl. 362/311.01; 313/318.12; 313/483; 362/351

(57) ABSTRACT

A light bulb includes a bulb body, two electrodes, and a light-transmissible conductive film. The two electrodes are connected to the bulb body. The light-transmissible conductive film covers the bulb body. A lighting fixture includes a lampshade, a cover, and a light-transmissible conductive film. The lampshade has an opening. The cover covers the opening. The light-transmissible conductive film is configured to be attached to the lampshade and the cover.

### BACKGROUND OF THE INVENTION

1. Field of the Invention

The invention relates to a light bulb and a lighting fixture capable of reducing electromagnetic radiation, and more particularly to a light bulb and a lighting fixture including a light-transmissible conductive film and a light-transmissible insulation film, capable of reducing electromagnetic radiation and avoiding human bodies from electric shock due to electric leakage or poor grounding.

2. Description of the Related Art

A commercially available energy saving light bulb is indeed a ball-shaped fluorescent bulb. As compared to an incandescent lamp of the same luminance, an energy saving light bulb has higher luminous efficiency and saves more energy.

Referring to FIG. 1, a ball-shaped energy saving light bulb 10 includes a bulb body 103, a first electrode 104, an electrical insulation part 105, and a second electrode 106, respectively described in the following:

The bulb body 103 includes a light-transmissible part 101 and a mount 102. In operation, the energy saving light bulb 10 emits light from the light-transmissible part 101. A starter, an electrical ballast, and other electrical components (not shown) are placed in the mount 102.

The first electrode 104 is connected as a ground contact for an indoor power supply (110V) and the second electrode 106 is connected as a live contact for the indoor power supply (110V). The first electrode 104 and the second electrode 106 are spaced apart by the electrical insulation part 105.

As previously described, an energy saving light bulb 10 saves more energy than an incandescent lamp. When in use, electromagnetic waves are generated by the energy saving light bulb 10 which is connected to a high-frequency alternating current source. Research has shown that the energy level of the electromagnetic waves generated by energy saving light bulbs is harmful to human bodies. Particularly, long-term exposure to such electromagnetic waves may affect human muscle and nervous system, and can even cause cancer.

### BRIEF SUMMARY OF THE INVENTION

The invention provides a light bulb and a lighting fixture capable of reducing electromagnetic radiation and avoiding human bodies from electric shock due to electric leakage or poor grounding. The light bulb in accordance with an exemplary embodiment of the invention includes a bulb body, two electrodes, and a light-transmissible conductive film. The two electrodes are connected to the bulb body. The light-transmissible conductive film covers the bulb body.

In another exemplary embodiment, one of the electrodes is a grounding electrode to which the light-transmissible conductive film is electrically connected.

In yet another exemplary embodiment, the light bulb further includes a light-transmissible insulation film covering the light-transmissible conductive film.

In another exemplary embodiment, the light-transmissible conductive film includes nano-scale metal film, conductive compounds, transparent conductive adhesive, or transparent conductive oxide.

In yet another exemplary embodiment, the light-transmissible conductive film is made of materials that only allow wavelengths of visible light spectrum to pass through.

The light bulb may be an incandescent bulb, a light emitting diode light, an energy saving light bulb, or a fluorescent bulb.

The lighting fixture in accordance with an exemplary embodiment of the invention includes a lampshade and a light bulb disposed in the lampshade. The light bulb includes a bulb body, two electrodes, and a light-transmissible conductive film. The two electrodes are connected to the bulb body. The light-transmissible conductive film covers the bulb body.

The lighting fixture in accordance with another exemplary embodiment of the invention includes a lampshade, a cover, and a light-transmissible conductive film. The lampshade has an opening. The cover covers the opening. The light-transmissible conductive film is configured to be attached to the lampshade and the cover.

In yet another exemplary embodiment, the lampshade and the cover include outer surfaces to which the light-transmissible conductive film is configured to be attached.

In another exemplary embodiment, the lampshade and the cover include inner surfaces to which the light-transmissible conductive film is configured to be attached.

In yet another exemplary embodiment, the lighting fixture further includes a light-transmissible insulation film covering the light-transmissible conductive film.

In another exemplary embodiment, the light-transmissible conductive film includes nano-scale metal film, conductive compounds, transparent conductive adhesive, or transparent conductive oxide.

In yet another exemplary embodiment, the light-transmissible conductive film is made of materials that only allow wavelengths of visible light spectrum to pass through.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a conventional ball-shaped energy saving light bulb;

FIG. 2 is a schematic diagram of a light bulb capable of reducing electromagnetic radiation in accordance with a first embodiment of the invention;

FIG. 3 is a sectional view of the light bulb along of FIG. 2, with the internal structure removed;

FIG. 4 is a schematic diagram of a light bulb capable of reducing electromagnetic radiation in accordance with a second embodiment of the invention;

FIG. 5 is a sectional view of the light bulb along V-V of FIG. 4, with the internal structure removed;

FIG. 6 is a schematic diagram of a light bulb capable of reducing electromagnetic radiation in accordance with a third embodiment of the invention;

FIG. 7 is a sectional view of the light bulb along VII-VII of FIG. 6, with the internal structure removed;

FIG. 8 is a schematic diagram of a light bulb and a lighting fixture in accordance with a fourth embodiment of the invention;

FIG. 9 is a schematic diagram of a light bulb and a lighting fixture in accordance with a fifth embodiment of the invention;

FIG. 10 depicts a traditional energy saving light bulb installed in a desk lamp for an experiment;

FIG. 11 depicts an energy saving light bulb of the second embodiment installed in the desk lamp of FIG. 10 for an experiment;

FIG. 12 depicts the signal of the electromagnetic radiation from the traditional energy saving light bulb of FIG. 10; and

FIG. 13 depicts the signal of the electromagnetic radiation from the energy saving light bulb of FIG. 11.

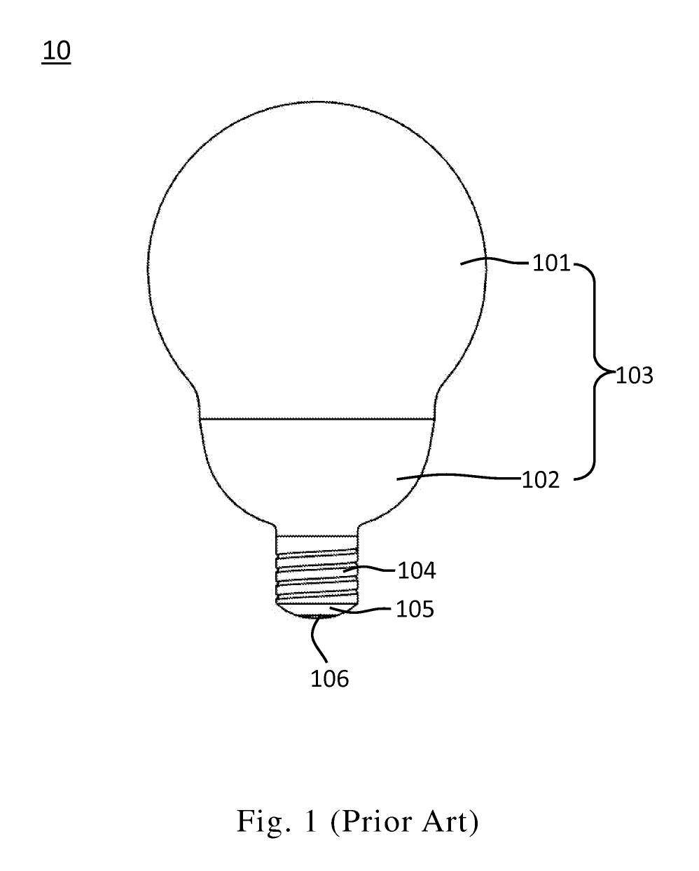

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

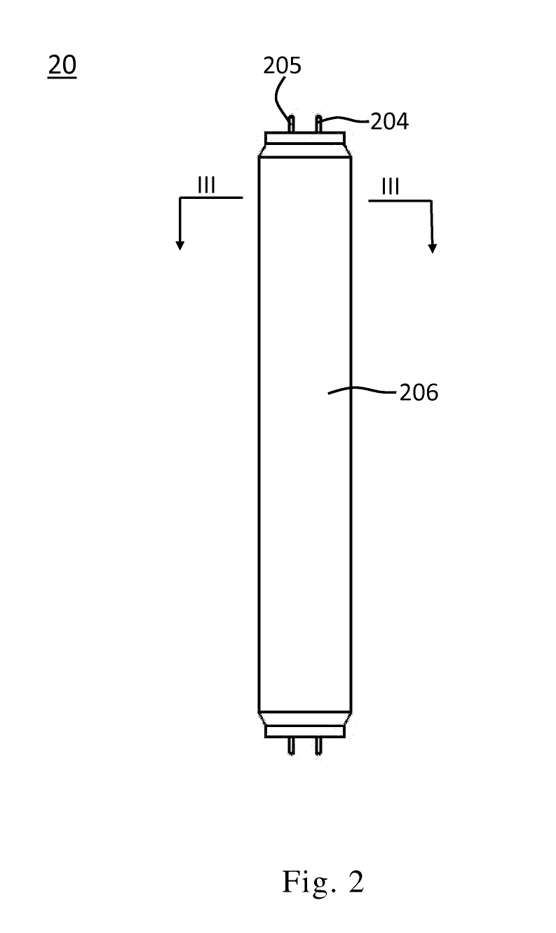

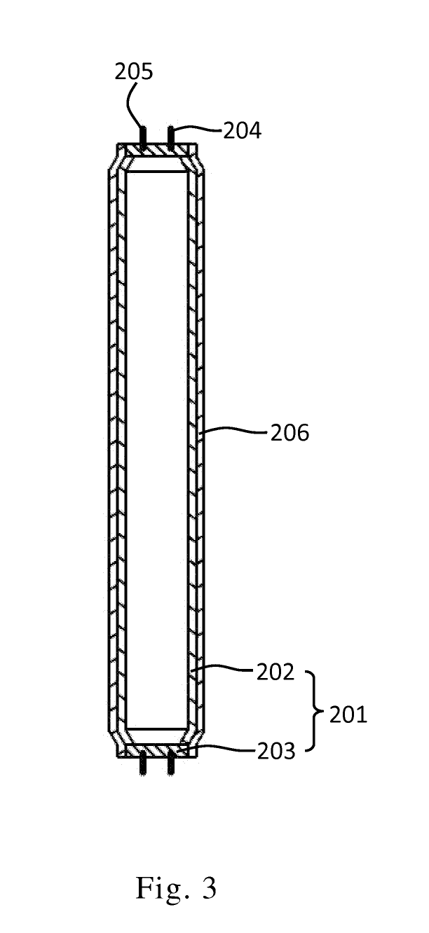

Referring to FIG. 2 and FIG. 3, FIG. 2 is a schematic diagram of a light bulb capable of reducing electromagnetic radiation in accordance with a first embodiment of the invention, and FIG. 3 is a sectional view of the light bulb along of FIG. 2, with the internal structure removed (not shown).

As shown, in the first embodiment, a fluorescent bulb 20 includes a tubular bulb body 201 and a light-transmissible conductive film 206 covering the tubular bulb body 201. The light-transmissible conductive film 206 functions as a shield for preventing electromagnetic wave leakage.

The tubular bulb body 201 includes a light-transmissible part 202 sealed by caps 203 at both ends. In operation, light is emitted after passing through the light-transmissible part 202 and the light-transmissible conductive film 206.

The materials of the light-transmissible conductive film 206 may be, for example, nano-scale metal film, conductive compounds, transparent conductive adhesive, or transparent conductive oxide (TCO). Preferably, the light-transmissible conductive film 206 is made of materials that only allow wavelengths of visible light spectrum to pass through, for filtering out ultraviolet rays, infrared rays, and other harmful rays.

The conductive compounds may be nitride (e.g. titanium nitride, TiN), silicide (e.g. titanium silicide, TiSi₂), etc., which are light-transmissible when the thickness thereof are at nano-scale. The tubular bulb body 201 has two ends. Each of the ends includes a first electrode 204 and a second electrode 205. Because connecting the fluorescent bulb 20 to a lighting fixture is not limited in one orientation, either the first electrode 204 or the second electrode 205 may be the ground contact for an indoor power supply (110V). In this embodiment, therefore, the light-transmissible conductive film 206 is not electrically connected to the first electrode 204 and the second electrode 205.

As previously described, the bulb body 201 of the fluorescent bulb 20 is covered by the light-transmissible conductive film 206. In operation, the light-transmissible conductive film 206 absorbs and blocks electromagnetic waves generated by the fluorescent bulb 20. Thus, injuries to human bodies caused by long-term exposure to fluorescent light can be effectively reduced.

Furthermore, the light-transmissible conductive film 206, if made of materials only allowing penetration of visible light, is capable of absorbing ultraviolet rays and infrared rays generated by the fluorescent bulb 20, and significantly reduces the risk of injuries done to human bodies by the ultraviolet rays and the infrared rays.

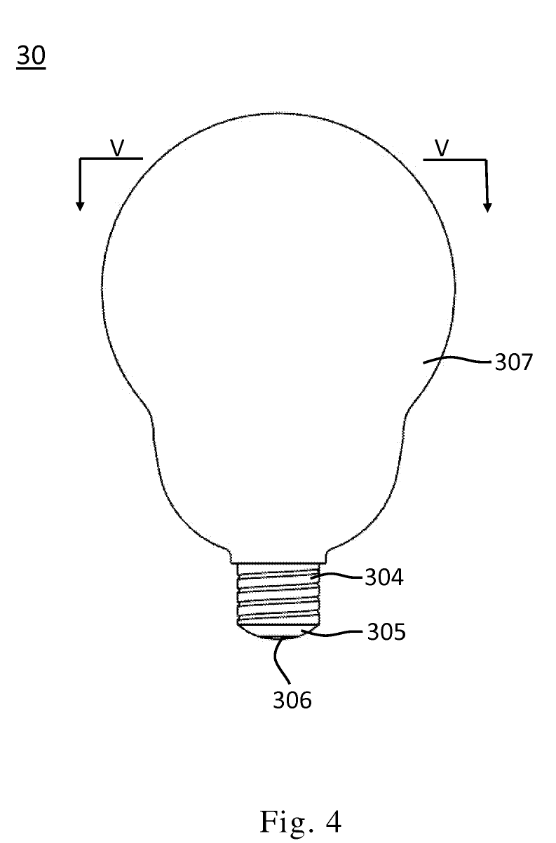

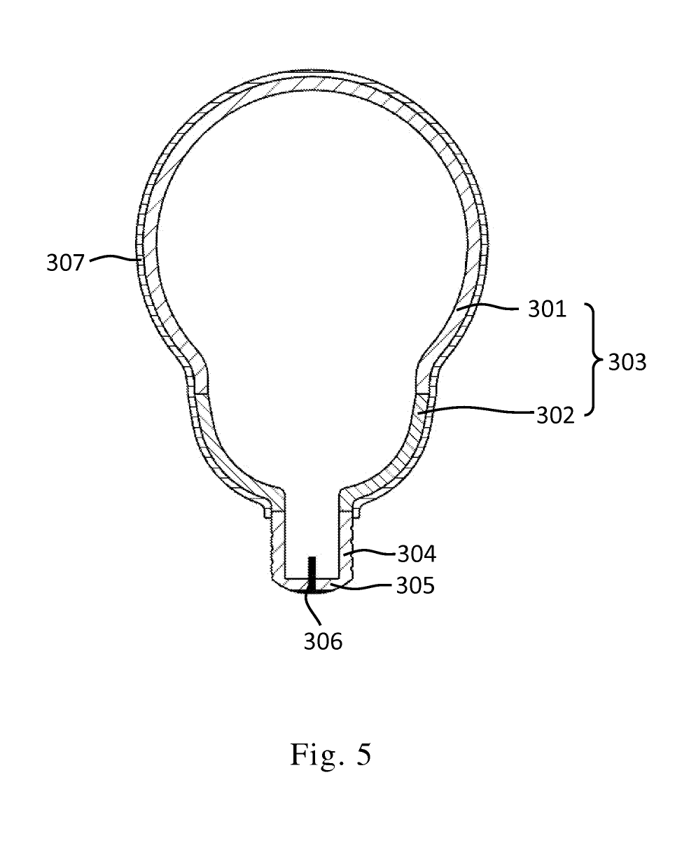

Referring to FIG. 4 and FIG. 5, FIG. 4 is a schematic diagram of a light bulb capable of reducing electromagnetic radiation in accordance with a second embodiment of the invention, and FIG. 5 is a sectional view of the light bulb along V-V of FIG. 4, with the internal structure removed (not shown).

As shown, in the second embodiment, a ball-shaped energy saving light bulb 30 includes a bulb body 303, a first electrode 304, an electrical insulation part 305, a second electrode 306, and a light-transmissible conductive film 307, respectively described in the following:

The bulb body 303 includes a light-transmissible part 301 and a mount 302. A starter, an electrical ballast, and other electrical components (not shown) are placed in the mount 302. The bulb body 303 is covered by the light-transmissible conductive film 307. In operation, light is emitted after passing through the light-transmissible part 301 and the light-transmissible conductive film 307.

The first electrode 304 is connected as a ground contact for an indoor power supply (110V) and the second electrode 306 is connected as a live contact for the indoor power supply (110V). The first electrode 304 and the second electrode 306 are spaced apart by the electrical insulation part 305.

Note that the light-transmissible conductive film 307 not only covers the bulb body 303 but electrically connects to the first electrode (grounding electrode) 304 for enhancing electromagnetic shielding and preventing injuries to human bodies caused by long-term exposure to fluorescent light.

Similarly, in the second embodiment, the light-transmissible conductive film 307 may be made of materials that only allow wavelengths of visible light spectrum to pass through, for example, nano-scale metal film, conductive compounds, transparent conductive adhesive, or transparent conductive oxide (TCO).

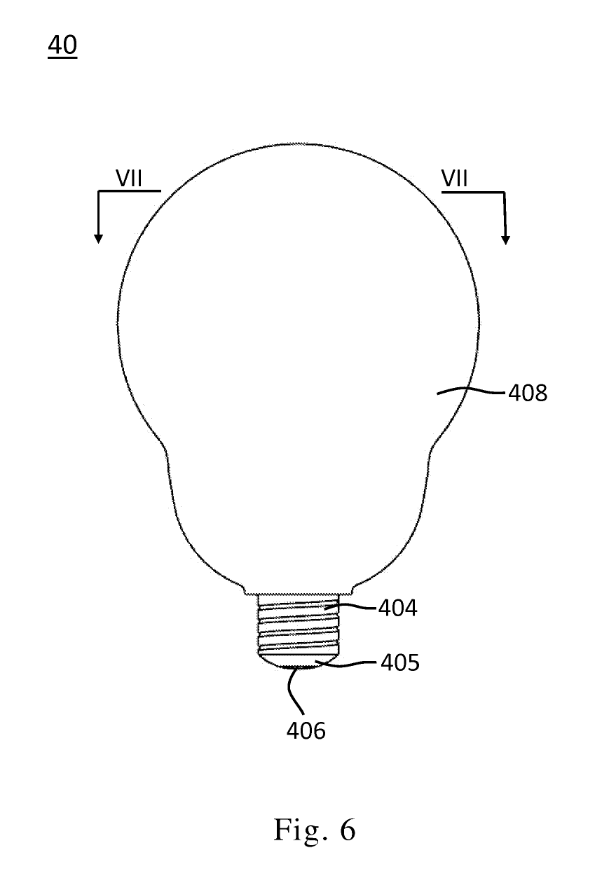

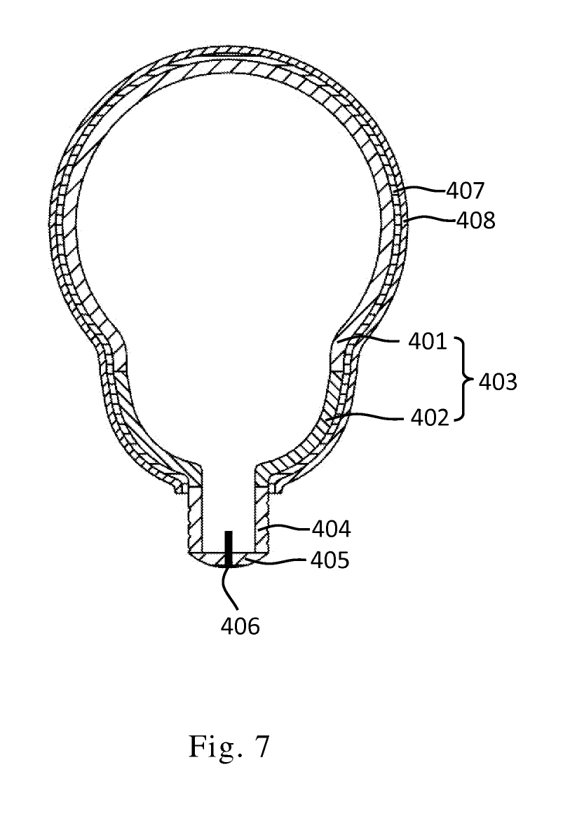

Referring to FIG. 6 and FIG. 7, FIG. 6 is a schematic diagram of a light bulb capable of reducing electromagnetic radiation in accordance with a third embodiment of the invention, and FIG. 7 is a sectional view of the light bulb along VII-VII of FIG. 6, with the internal structure removed (not shown).

As shown, in the third embodiment, a ball-shaped energy saving light bulb 40 includes a bulb body 403, a first electrode 404, an electrical insulation part 405, a second electrode 406, a light-transmissible conductive film 407, and a light-transmissible insulation film 408, respectively described in the following:

The bulb body 403 includes a light-transmissible part 401 and a mount 402. A starter, an electrical ballast, and other electrical components (not shown) are placed in the mount 402. The bulb body 403 is covered by the light-transmissible conductive film 407, and the light-transmissible conductive film 407 is covered by the light-transmissible insulation film 408. In operation, light is emitted after passing through the light-transmissible part 401, the light-transmissible conductive film 407 and the light-transmissible insulation film 408.

The first electrode 404 is connected as a ground contact for an indoor power supply (110V) and the second electrode 406 is connected as a live contact for the indoor power supply (110V). The first electrode 404 and the second electrode 406 are spaced apart by the electrical insulation part 405.

Note that the light-transmissible conductive film 407 not only covers the bulb body 403 but electrically connects to the first electrode (grounding electrode) 404 for enhancing electromagnetic shielding and preventing injuries to human bodies caused by long-term exposure to fluorescent light.

Similarly, in the third embodiment, the light-transmissible conductive film 407 may be made of materials that only allow wavelengths of visible light spectrum to pass through, for example, nano-scale metal film, conductive compounds, transparent conductive adhesive, or transparent conductive oxide (TCO).

Note that, in the third embodiment, the light-transmissible conductive film 407 is covered by the light-transmissible insulation film 408. Such an arrangement avoids physical contact with the light-transmissible conductive film 407 by human bodies. Thus, an electric shock to human bodies arising from electric leakage or poor grounding can be avoided.

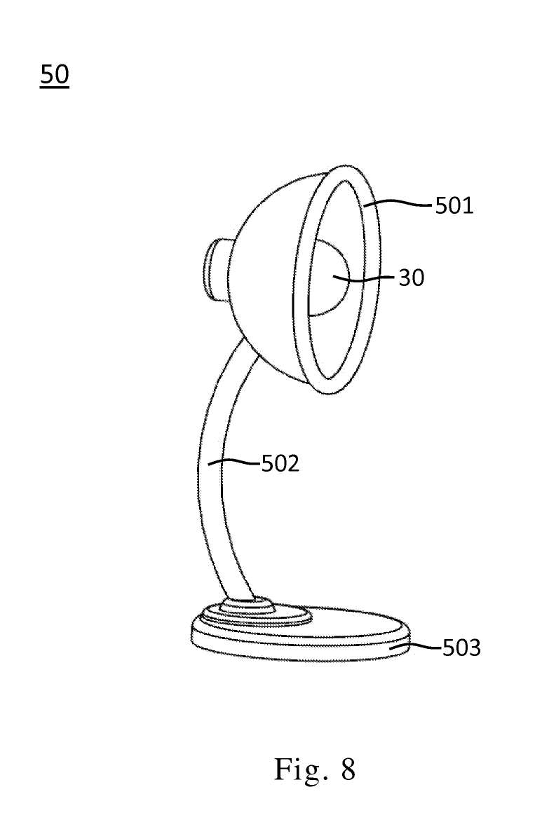

FIG. 8 is a schematic diagram of a light bulb and a lighting fixture in accordance with a fourth embodiment of the invention, wherein the energy saving light bulb 30 of the second embodiment is installed in a lighting fixture. In the fourth embodiment, the lighting fixture is a desk lamp 50 including a lampshade 501, a support arm 502, and a base 503. The support arm 502 extends from the base 503 to the lampshade 501. The light bulb 30 is installed in the lampshade 501.

An ordinary, commercially available desk lamp is used as the lighting fixture in the fourth embodiment. The risk of injuring human bodies by electromagnetic waves in operation of the desk lamp can be greatly reduced, because the energy saving light bulb 30 has the electromagnetic shielding structure of the invention.

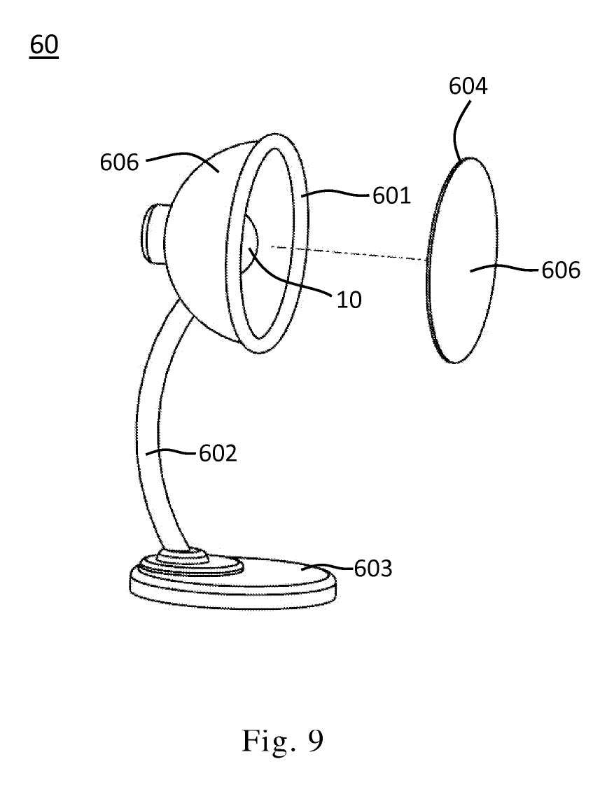

FIG. 9 is a schematic diagram of a light bulb and a lighting fixture in accordance with a fifth embodiment of the invention, wherein the light bulb 10 is ordinary and commercially available. In operation, the light bulb 10 generates electromagnetic waves the energy level of which is harmful to human bodies. However, the lighting fixture 60 is provided with electromagnetic shielding structure to block the electromagnetic waves.

As shown, the lighting fixture 60 includes a lampshade 601, a support arm 602, a base 603, a cover 604, and a light-transmissible conductive film 606, described in the following:

The lampshade 601 includes an opening which is covered by the cover 604. The cover 604 is made of, for example, glass, acrylic, transparent plastic sheet, or others.

The support arm 602 extends from the base 603 to the lampshade 601. The light bulb 10 is installed in the lampshade 601.

The light-transmissible conductive film 606 is provided on the outer surfaces of the lampshade 601 and the cover 604 to envelop the light bulb 10, for protecting human bodies by blocking the electromagnetic waves generated by the light bulb 10.

Similarly, the light-transmissible conductive film 606 may be made of visible light transmissible materials, for example, nano-scale metal film, conductive compounds, transparent conductive adhesive, transparent conductive oxide (TCO), or others.

A light-transmissible insulation film (not shown) may be provided on the light-transmissible conductive film 606, similar to that of the third embodiment, to avoid human bodies from electric shock due to electric leakage or poor grounding.

In the fifth embodiment, the light-transmissible conductive film 606 is provided on the outer surfaces of the lampshade 601 and the cover 604 to envelop the light bulb 10. However, it is understood that the light-transmissible conductive film 606 may be provided on the inner surfaces of the lampshade 601 and the cover 604 to envelop the light bulb 10 and provide the same electromagnetic shielding.

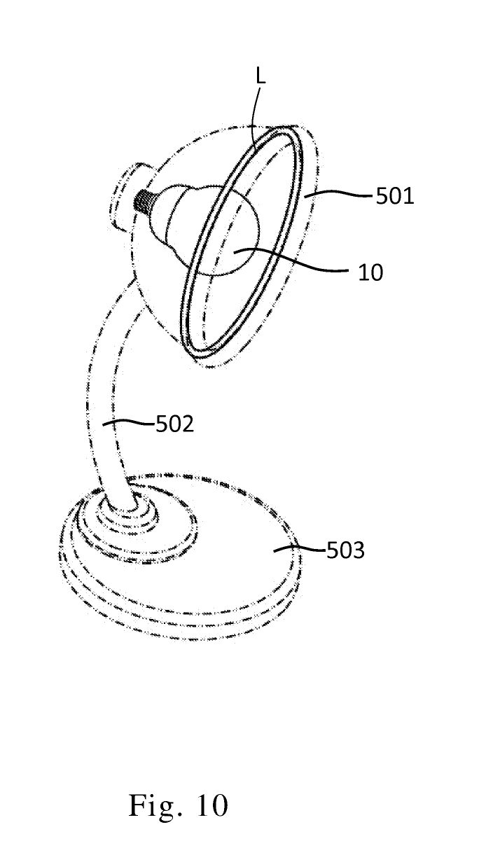

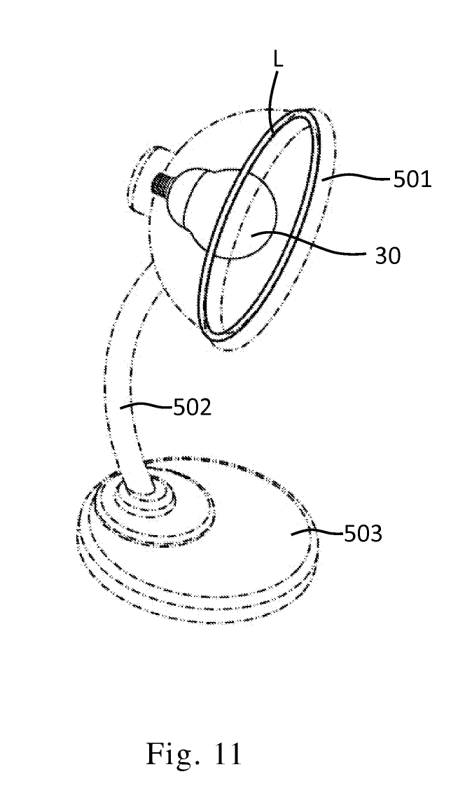

An experiment was made for verifying the effect of the invention. A traditional energy saving light bulb 10 shown in FIG. 10 and an energy saving light bulb 30 of the second embodiment shown in FIG. 11 were respectively installed in an ordinary desk lamp. An electric wire L, wound around the lampshade 501, functioned as a simple antenna for measuring electromagnetic radiation. An oscilloscope was provided to show the signals of the electromagnetic radiation from the two energy saving light bulbs 10 and 30.

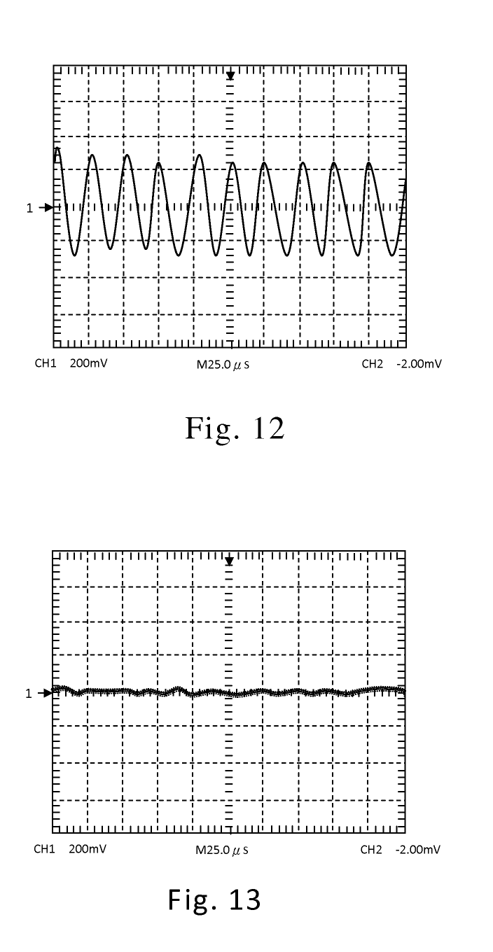

The signal of the electromagnetic radiation from the traditional energy saving light bulb 10 is shown in FIG. 12, which varies remarkably. Also, the signal of the electromagnetic radiation from the energy saving light bulb 30 of the invention is shown in FIG. 13, the variation of which is very limited. The experiment showed that the electromagnetic radiation can be effectively absorbed and blocked by the light-transmissible conductive film 307 of the energy saving light bulb 30 of the invention.

Light bulbs and lighting fixtures using a high-frequency alternating current (AC) power supply are described in the above embodiments of the invention. Nevertheless, it is understood that the invention is applicable to other types of light bulbs (e.g. incandescent bulbs, light emitting diode lights, etc.) which generate a small quantity of electromagnetic waves in operation.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light bulb, comprising:
a bulb body;
two electrodes connected to the bulb body; and
a light-transmissible conductive film covering the bulb body.

2. The light bulb as claimed in claim 1, wherein one of the electrodes is a grounding electrode to which the light-transmissible conductive film is electrically connected.

3. The light bulb as claimed in claim 1, further comprising a light-transmissible insulation film covering the light-transmissible conductive film.

4. The light bulb as claimed in claim 1, wherein the light-transmissible conductive film comprises nano-scale metal film, conductive compounds, transparent conductive adhesive, or transparent conductive oxide.

5. The light bulb as claimed in claim 1, wherein the light-transmissible conductive film is made of materials that only allow wavelengths of visible light spectrum to pass through.

6. The light bulb as claimed in claim 1, wherein the light bulb is an incandescent bulb, a light emitting diode light, an energy saving light bulb, or a fluorescent bulb.

7. A lighting fixture, comprising:
a lampshade; and
the light bulb as claimed in claim 1, disposed in the lampshade.

8. A lighting fixture, comprising:
a lampshade comprising an opening;
a cover covering the opening; and
a light-transmissible conductive film configured to be attached to the lampshade and the cover.

9. The lighting fixture as claimed in claim 8, wherein the lampshade and the cover comprise outer surfaces to which the light-transmissible conductive film is configured to be attached.

10. The lighting fixture as claimed in claim 8, wherein the lampshade and the cover comprise inner surfaces to which the light-transmissible conductive film is configured to be attached.

11. The lighting fixture as claimed in claim 8, further comprising a light-transmissible insulation film covering the light-transmissible conductive film.

12. The lighting fixture as claimed in claim 8, wherein the light-transmissible conductive film comprises nano-scale metal film, conductive compounds, transparent conductive adhesive, or transparent conductive oxide.

13. The lighting fixture as claimed in claim 8, wherein the light-transmissible conductive film is made of materials that only allow wavelengths of visible light spectrum to pass through.
